(19) United States
(12) Patent Application Publication
(10) Pub. No.: US 2002/0074736 A1
(43) Pub. Date: Jun. 20, 2002

(54) Sealing device for a rolling contact bearing

(75) Inventors: Angelo Vignotto, Torino (IT); Massimo Marivo, Airasca (IT)

Correspondence Address: MERCHANT & GOULD PC, P.O. BOX 2903, MINNEAPOLIS, MN, 55402-0903, US

(73) Assignee: SKF INDUSTRIE S.p.A.

(21) Appl. No.: 10/022,095

(22) Filed: Dec. 17, 2001

(30) Foreign Application Priority Data
Dec. 20, 2000 (IT) T02000A001187

(51) Int. Cl. F16J 15/32

(52) U.S. Cl. 277/562

(57) ABSTRACT

Sealing device (1) for a rolling contact bearing (2) provided with two races (3, 4) which are coaxial to each other; the sealing device presents two inserts (5, 6) which are made of metal material and which are each coupled to a relative race, at least one sealing lip (8) which extends between the two inserts (5, 6), and a phonic wheel (9) which is supported by the more external (5) of the two said inserts (5, 6); the more external insert (5) being in its turn provided with an annular housing (19) for containing the phonic wheel (9) which is axially open towards the outside of the bearing (2) and which presents a shield (20) which is made of vulcanised rubber and which is arranged in such a way as to completely seal the said housing (19) itself.

The present invention relates to a sealing device for a rolling contact bearing.

In particular, the present invention relates to a sealing device which is mounted between an inner race and an outer race of a rolling contact bearing in order to prevent the entry of solid impurities as well as any loss of lubrication, and comprising a first shield which is made of metal material and which is coupled to the outer race, a second shield which is made of metal material and which is coupled to the inner race and which is frontally arranged in relation to the first shield, and a seal which is made of synthetic material and which is integral to the first shield and which is provided with a sealing lip which extends between the two shields in the space delimited by the two shield themselves.

There is a tendency, in the rolling contact bearing industry, to integrate sealing devices of the type described above with the devices which measure the relative rotation speed of the two races of the bearing, which is to say that there is a tendency to make a magnetised phonic wheel of the measuring device an integral part of the relative sealing device.

As, however, phonic wheels are generally fragile, the most commonly adopted alternative for carrying out this kind of integration is to arrange the phonic wheel between the two shields by mounting it against the more external of the two shields.

While this alternative protects the phonic wheel from impact and from any damage which might be caused during assembly or transport or by magnetisation, it does present some disadvantages which are due to the interposition of the shield made of metal material between the phonic wheel and, depending on the method adopted, the magnetiser or the sensor. Furthermore, this alternative reduces the chances of using different kinds of phonic wheels which, for some applications, could even be more cost-effective than those which currently have to be used in order to combat the undesirable shielding effect produced by the shield.

The aim of the present invention is to produce a sealing device for rolling contact bearings which will remove the disadvantages described above in a simple, cost-effect way.

According to the present invention, a sealing device for a roller contact bearing will be realised comprising two races which are coaxial to each other; the device comprises two inserts which are made of metal material and which are each coupled to a relative race, at least one sealing lip which extends between the said two inserts, and a phonic wheel which is supported by the more external of the said two inserts; and being characterised by the fact that the more external of the two inserts comprises an annular housing for containing the phonic wheel which is axially open towards the outside of the bearing, and which presents a shield which is made of vulcanised rubber material and which is arranged in such a way as to completely seal the housing itself.

The present invention will now be described with reference to the attached drawings, which illustrate a non-limiting embodiment of it and in which:

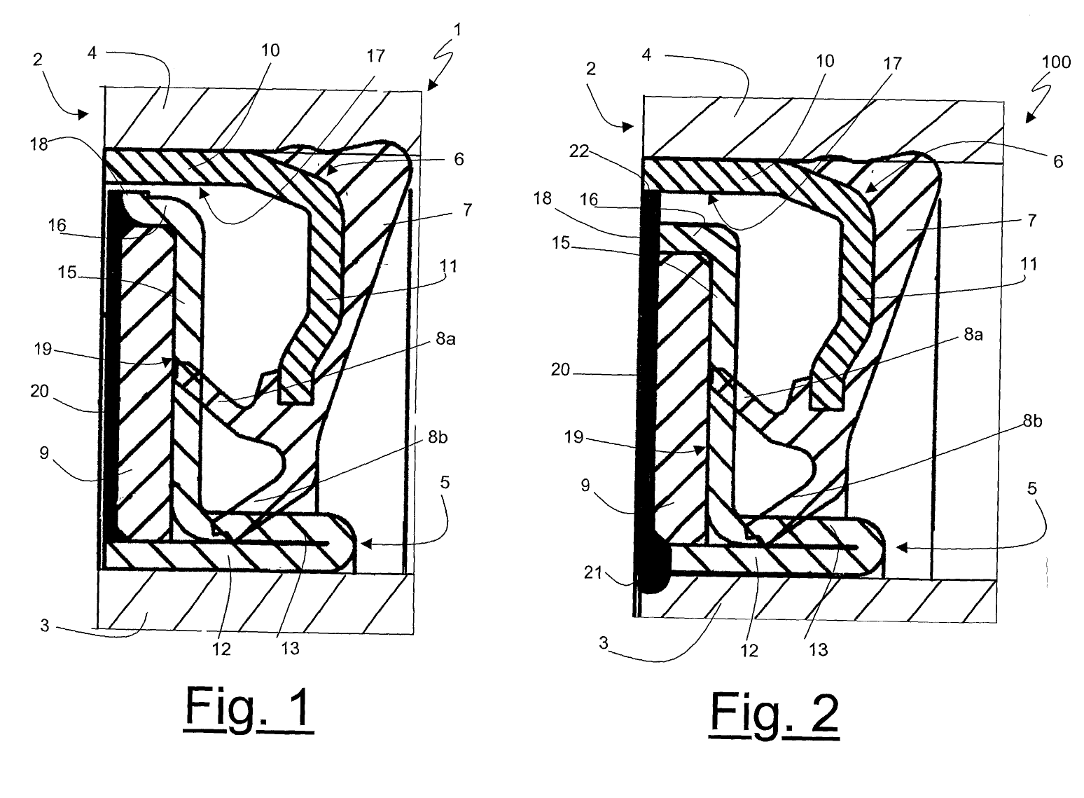

FIG. 1 shows an axial section view a first preferred form of embodiment of a sealing device for rolling contact bearings which is realised according to the present invention; and

FIG. 2 shows an axial section view of a second preferred form of embodiment of the sealing device for rolling contact bearings which is illustrated in FIG. 1.

With reference to FIG. 1, the number 1 indicates, in its entirety, a sealing device for a rolling contact bearing 2 comprising an inner race 3 and an outer race 4 which are coaxial to each other.

The device 1 comprises two inserts 5 and 6 which are made of metal material and which are respectively coupled to the races 3 and 4, and a lining 7 which is made of synthetic material and which is integral to the insert 6, and which presents two sealing lips 8a and 8b which extend in different directions one from the other until they come into contact with the insert 5.

Finally, the sealing device 1 comprises a phonic wheel 9, which is supported by the insert 5, which is the more axially external of the two inserts 5 and 6.

In an axial section, which is to say in a section obtained with a plan containing the non-illustrated rotation axis of the bearing 2, the insert 6 presents a substantially L-shaped form and comprises a cylindrical wall 10 which is assembled in direct contact with the race 4, and an annular shaped wall 11, which is substantially transverse to the wall 10 and which defines a support for the lining 7.

The insert 5 comprises two cylindrical walls 12 and 13, which are radially superimposed one over the other, and from which the walls 12 and 13 are arranged in direct contact with the race 3, and it presents a section 14 which is of a length which is substantially equal to an axial thickness of the phonic wheel 9. The section 14 projects axially towards the outside of the bearing 2 in relation to the wall 13, and defines an internal radial support for the phonic wheel 9.

The insert 5 also comprises an annular wall 15, which is integral to the wall 13, and which extends transverse to the wall 13 itself and radially towards the wall 10 of the insert 6. The wall 15 and the wall 11 are axially staggered and radially superimposed in relation to each other: the two lips 8 are arranged where the two walls 15 and 11 are not superimposed. In particular, the lip 8a is arranged against the wall 15, while the lip 8b is arranged against the wall 13.

Finally, the insert 5 comprises a further cylindrical wall 16, which is integral to the wall 15, and which extends transverse to the wall 15 itself towards the outside of the bearing 2. Furthermore, the wall 16 defines with the wall 10 an annular channel 17 for the expulsion of contaminating material from the inside of the device 1, and presents a cylindrical edge 18 which is folded towards the wall 10 itself.

The section 14 of the wall 10, the wall 15 and the wall 16 define between them an annular housing 19 for containing the phonic wheel 9. In particular, the housing 19 is axially open towards the outside of the bearing 2, and comprises a shield 20 which is made of vulcanised rubber, which is arranged in such a way as to completely seal the housing 19 and to completely block the phonic wheel inside the housing 19 itself.

The shield 20 is realised after the phonic wheel 9 has been positioned, with a certain allowance, inside the housing 19, and it radially extends along the entire housing 19 itself, staring from the section 14 until it reaches an outer radial limit which is defined by the edge 18.

The shield 20 presents an axial thickness which it substantially constant for at least the section which is arranged in direct contact with the phonic wheel 9, and it protects the phonic wheel 9 itself without defining any kind of obstacle for the magnetiser of the sensor.

The form of embodiment illustrated in FIG. 2 relates to a sealing device 100 for a rolling contact bearing 2 similar to the sealing device 1, from which the sealing device 100 is different due to the fact that the edge 18 is not folded towards the wall 10, but is arranged transverse to the above-mentioned rotation axis of the bearing 2. Furthermore, the shield 20 comprises two radial opposite ends 21 and 22, which respectively define a static seal against the race 3, and a dynamic seal which substantially seals the annular channel 17.

It is obvious from the above description that both the sealing device 1 and the sealing device 100 enable a phonic wheel 9 to be assembled to the more external shield 5 and that the sealing device 1 and the sealing device 100 also protect the phonic wheel 9 itself by means of a simple shield 20, the reduced thickness of which, and the material of which it is made, result in the elimination of some of the disadvantages encountered in the devices described in the introduction above.

In fact, the shield 20 provides the phonic wheel 9 with an excellent level of magnetisation, in that it reduces any errors due to parallelism and perpendicularity, and that it enables the phonic wheel 9 to come into contact with the magnetiser without causing any damage to either the phonic wheel 9 itself or the magnetiser itself. Furthermore, the shield 20 can be used with any kind of phonic wheel 9, which means that the amount of magnet material contained in the phonic wheel 9 itself can be increased without having to worry about any eventual fragility presented by the phonic wheel 9 itself.

Furthermore, as has been previously stated, the shield 20 is made of rubber, which is vulcanised after the phonic wheel 9 has been introduced into the housing 19, so that it is possible to use a phonic wheel 9 with dimensions which are smaller that those of the housing 19; any eventual allowance will then be filled by the rubber of the shield 20 when it is vulcanised.

Finally, the use of the shield 20 which has just been described means that the housing 19 is completely hermetically sealed and, as described in relation to the sealing device 100, it also means that the sealing device 100 itself is insulated from the inside.

It is intended that the present invention should not be limited to the forms of embodiment herein described and illustrated, which are to be considered as examples of preferred forms of embodiment for a sealing device for a rolling contact bearing, which might be subject to further modifications in relation to the shape and disposition of its parts, constructive details and assembly.

1. Sealing device (1) (100) for a rolling contact bearing (2) comprising two races (3, 4) which are coaxial to each other; the device comprises two inserts (5, 6) which are made of metal material and which are each coupled to a relative race (3, 4), at least one sealing lip (8) which extends between the said two inserts (5, 6), and a phonic wheel (9) which is supported by the more external (5) of the said two inserts (5, 6); and being characterised by the fact that the more external of the two inserts (5) comprises an annular housing (19) for containing the phonic wheel (9) which is axially open towards the outside of the bearing (2), and which presents a shield (20) which is made of vulcanised rubber material and which is arranged in such a way as to completely seal the housing (19) itself.

2. Sealing device according to claim 1, characterised by the fact that the said housing (19) is radially delimited by a first and a second cylindrical wall (12, 16) which form part of the said more external insert (5); the first cylindrical wall (12) defines an internal radial support for the said phonic wheel (9), and the second wall defines an annular channel (17) with the other insert (6).

3. Sealing device according to claim 2, characterised by the fact that the said second wall (16) presents a cylindrical edge (18), which is folded towards the other insert (6) and which defines an outer radial limit for the shield made of vulcanised rubber (20).

4. Sealing device according to claim 3, characterised by the act that the said shield (20) comprises two opposite radial ends (21, 22) which respectively define a static seal against a race (3) of the bearing (2), and a dynamic seal which substantially seals the said annular channel (17).
